(19) United States
(12) Patent Application Publication
(10) Pub. No.: US 2025/0156687 A1
(43) Pub. Date: May 15, 2025

(54) System, Method, and Computer Program Product for Secure Edge Computing of a Machine Learning Model

(71) Applicant: Visa International Service Association, San Francisco, CA (US)

(72) Inventors: Miaomiao Liu, Merced, CA (US); Runxin He, Cedar Park, TX (US); Yinhe Cheng, Austin, TX (US); Yu Gu, Austin, TX (US)

(21) Appl. No.: 18/834,716

(22) PCT Filed: Feb. 1, 2023
(86) PCT No.: PCT/US23/12076

§ 371 Date: Jul. 31, 2024

Related U.S. Application Data
(60) Provisional application No. 63/305,845, filed on Feb. 2, 2022.

(51) Int. Cl. G06N 3/0455

(52) U.S. Cl. CPC G06N 3/0455

(57) ABSTRACT

Described are a system, method, and computer program product for secure edge computing of a machine learning model. The method includes transmitting, with a server, a first portion of a machine learning model to a computing device remote from the server. The first portion includes at least one first layer of the machine learning model configured to process a first input of data collected by the computing device and generate an output. The method also includes receiving, with the server from the computing device, encoded model data including the output. The method further includes decoding, with the server, the encoded model data to produce decoded model data, and generating, with the server, a classification based on the first input of data by executing a second portion of the machine learning model.

### CROSS REFERENCE TO RELATED APPLICATIONS

This application is the United States national phase of International Patent Application No. PCT/US2023/012076 filed Feb. 1, 2023, and claims priority to U.S. Provisional Patent Application No. 63/305,845 filed Feb. 2, 2022, the disclosures of which are hereby incorporated by reference in their entireties.

### BACKGROUND

### 1. Technical Field

Disclosed embodiments or aspects relate generally to edge computing and, in one particular embodiment or aspect, to a system, method, and computer program product for secure edge computing of machine learning models.

### 2. Technical Considerations

Executing a machine learning model entirely on a central server places reliance on the central server for computational resources (e.g., memory, bandwidth, etc.). The central server may execute the machine learning model based on communications with (e.g., in response to requests from) remote computing devices associated with system users. When executing machine learning models entirely on a central server, the computational load significantly increases for each instance. In contrast, executing machine learning models entirely on the computing devices of the users can create security issues. For example, by executing a machine learning model on a computing device of a user, the machine learning model and its feature engineering may be exposed. Furthermore, it is possible for a remote computing device to maliciously modify the output of the machine learning model when returning the results to the central server.

There is a need in the art for a technical solution to allow a machine learning model to be executed at least partly on a computing device remote from a central server, while also maintaining model accuracy and security when implementing the machine learning model in an edge computing framework.

### SUMMARY

Accordingly, and generally, provided is an improved system, method, and computer program product for secure edge computing of a machine learning model.

According to some non-limiting embodiments or aspects, provided is a computer-implemented method for secure edge computing of a machine learning model. The method includes transmitting, with a server including at least one processor, a first portion of a machine learning model to at least one computing device remote from the server. The first portion includes at least one first layer of the machine learning model configured to process a first input of data collected by the at least one computing device and generate an output. The method also includes receiving, with the server from the at least one computing device, encoded model data including the output of the at least one first layer of the machine learning model. The method further includes decoding, with the server, the encoded model data to produce decoded model data. The method further includes generating, with the server, a classification based on the first input of data by executing a second portion of the machine learning model. The second portion includes at least one second layer of the machine learning model configured to output the classification based on processing an input of the decoded model data.

In some non-limiting embodiments or aspects, the method may further include, in response to receiving the encoded model data from the at least one computing device and decoding the encoded model data, evaluating, with the server, the decoded model data to determine whether the encoded model data was modified without permission.

In some non-limiting embodiments or aspects, the method may further include, in response to determining that the encoded model data was modified without permission: updating, with the server, a total count of instances of unpermitted modifications to model data; and executing, with the server and based on the total count, a mitigation process to prevent future unpermitted modifications to model data.

In some non-limiting embodiments or aspects, the method may further include, in response to determining that the encoded model data was not modified without permission: profiling, with the server, historic data of activity of a plurality of computing devices occurring over a first time interval; and generating, with the server and further based on the historic data, the classification.

In some non-limiting embodiments or aspects, the first input of data collected by the at least one computing device may include data of activity of the at least one computing device occurring over a second time interval shorter than the first time interval.

In some non-limiting embodiments or aspects, the method may further include receiving, with the server, a transaction request from the at least one computing device. The method may further include processing, with the server, the transaction request based on the classification. The machine learning model may be a fraud detection model and the first input of data collected by the at least one computing device may include user credentials input to the at least one computing device by a user. The historic data of activity may include historic transaction data of transactions processed by the server in the first time interval. The classification generated by the server may be based on a likelihood of the transaction request being fraudulent.

In some non-limiting embodiments or aspects, the encoded model data may be produced by encryption and compression, and decoding the encoded model data may further include decrypting and uncompressing the encoded model data to produce the decoded model data.

According to some non-limiting embodiments or aspects, provided is a system for secure edge computing of a machine learning model. The system includes at least one processor. The at least one processor is programmed or configured to transmit a first portion of a machine learning model to at least one computing device remote from the at least one processor. The first portion includes at least one first layer of the machine learning model configured to process a first input of data collected by the at least one computing device and generate an output. The at least one processor is also programmed or configured to receive, from the at least one computing device, encoded model data including the output of the at least one first layer of the machine learning model. The at least one processor is further programmed or configured to decode the encoded model data to produce decoded model data. The at least one processor is further programmed or configured to generate a classification based on the first input of data by executing a second portion of the machine learning model. The second portion includes at least one second layer of the machine learning model configured to output the classification based on processing an input of the decoded model data.

In some non-limiting embodiments or aspects, the at least one processor may be further programmed or configured to, in response to receiving the encoded model data from the at least one computing device and decoding the encoded model data, evaluate the decoded model data to determine whether the encoded model data was modified without permission.

In some non-limiting embodiments or aspects, the at least one processor may be further programmed or configured to: (i) in response to determining that the encoded model data was modified without permission: update a total count of instances of unpermitted modifications to model data; and execute, based on the total count, a mitigation process to prevent future unpermitted modifications to model data. The at least one processor may be further programmed or configured to: (ii) in response to determining that the encoded model data was not modified without permission: profile historic data of activity of a plurality of computing devices occurring over a first time interval; and generate, further based on the historic data, the classification.

In some non-limiting embodiments or aspects, the first input of data collected by the at least one computing device may include data of activity of the at least one computing device occurring over a second time interval shorter than the first time interval.

In some non-limiting embodiments or aspects, the at least one processor may be further programmed or configured to receive a transaction request from the at least one computing device. The at least one processor may be further programmed or configured to process the transaction request based on the classification. The machine learning model may be a fraud detection model and the first input of data collected by the at least one computing device further may include user credentials input to the at least one computing device by a user. The historic data of activity may include historic transaction data of transactions processed by the server in the first time interval. The classification generated by the at least one processor may be based on a likelihood of the transaction request being fraudulent.

In some non-limiting embodiments or aspects, the encoded model data may be produced by encryption and compression, and decoding the encoded model data may further include decrypting and uncompressing the encoded model data to produce the decoded model data.

According to some non-limiting embodiments or aspects, provided is a computer program product for secure edge computing of a machine learning model. The computer program product includes at least one non-transitory computer-readable medium storing one or more instructions that, when executed by at least one processor of a server, cause at least one processor to transmit a first portion of a machine learning model to at least one computing device remote from the server. The first portion includes at least one first layer of the machine learning model configured to process a first input of data collected by the at least one computing device and generate an output. The one or more instructions also cause the at least one processor to receive, from the at least one computing device, encoded model data including the output of the at least one first layer of the machine learning model. The one or more instructions further cause the at least one processor to decode the encoded model data to produce decoded model data. The one or more instructions further cause the at least one processor to generate a classification based on the first input of data by executing a second portion of the machine learning model. The second portion includes at least one second layer of the machine learning model configured to output the classification based on processing an input of the decoded model data.

In some non-limiting embodiments or aspects, the one or more instructions may further cause the at least one processor to, in response to receiving the encoded model data from the at least one computing device and decoding the encoded model data, evaluate the decoded model data to determine whether the encoded model data was modified without permission.

In some non-limiting embodiments or aspects, the one or more instructions may further cause the at least one processor to, in response to determining that the encoded model data was modified without permission, update a total count of instances of unpermitted modifications to model data, and execute, based on the total count, a mitigation process to prevent future unpermitted modifications to model data.

In some non-limiting embodiments or aspects, the one or more instructions may further cause the at least one processor to, in response to determining that the encoded model data was not modified without permission, profile historic data of activity of a plurality of computing devices occurring over a first time interval, and generate, further based on the historic data, the classification.

In some non-limiting embodiments or aspects, the first input of data collected by the at least one computing device may include data of activity of the at least one computing device occurring over a second time interval shorter than the first time interval.

In some non-limiting embodiments or aspects, the one or more instructions may further cause the at least one processor to receive a transaction request from the at least one computing device, and process the transaction request based on the classification. The machine learning model may be a fraud detection model and the first input of data collected by the at least one computing device may further include user credentials input to the at least one computing device by a user. The historic data of activity may include historic transaction data of transactions processed by the server in the first time interval. The classification generated by the at least one processor of the server may be based on a likelihood of the transaction request being fraudulent.

In some non-limiting embodiments or aspects, the encoded model data may be produced by encryption and compression, and decoding the encoded model data may further include decrypting and uncompressing the encoded model data to produce the decoded model data.

Further non-limiting embodiments or aspects of the present disclosure are set forth in the following numbered clauses:

Clause 1: A computer-implemented method comprising: transmitting, with a server comprising at least one processor, a first portion of a machine learning model to at least one computing device remote from the server, the first portion comprising at least one first layer of the machine learning model configured to process a first input of data collected by the at least one computing device and generate an output; receiving, with the server from the at least one computing device, encoded model data comprising the output of the at least one first layer of the machine learning model; decoding, with the server, the encoded model data to produce decoded model data; and generating, with the server, a classification based on the first input of data by executing a second portion of the machine learning model, the second portion comprising at least one second layer of the machine learning model configured to output the classification based on processing an input of the decoded model data.

Clause 2: The computer-implemented method of clause 1, further comprising, in response to receiving the encoded model data from the at least one computing device and decoding the encoded model data: evaluating, with the server, the decoded model data to determine whether the encoded model data was modified without permission.

Clause 3: The computer-implemented method of clause 1 or clause 2, further comprising, in response to determining that the encoded model data was modified without permission: updating, with the server, a total count of instances of unpermitted modifications to model data; and executing, with the server and based on the total count of instances, a mitigation process to prevent future unpermitted modifications to model data.

Clause 4: The computer-implemented method of any of clauses 1-3, further comprising, in response to determining that the encoded model data was not modified without permission: profiling, with the server, historic data of activity of a plurality of computing devices occurring over a first time interval; and generating, with the server and further based on the historic data, the classification.

Clause 5: The computer-implemented method of any of clauses 1-4, wherein the first input of data collected by the at least one computing device comprises data of activity of the at least one computing device occurring over a second time interval shorter than the first time interval.

Clause 6: The computer-implemented method of any of clauses 1-5, further comprising: receiving, with the server, a transaction request from the at least one computing device; and processing, with the server, the transaction request based on the classification, wherein the machine learning model is a fraud detection model, wherein the first input of data collected by the at least one computing device further comprises user credentials input to the at least one computing device by a user, wherein the historic data of activity comprises historic transaction data of transactions processed by the server in the first time interval, and wherein the classification generated by the server is based on a likelihood of the transaction request being fraudulent.

Clause 7: The computer-implemented method of any of clauses 1-6, wherein the encoded model data is produced by encryption and compression, and wherein decoding the encoded model data further comprises decrypting and uncompressing the encoded model data to produce the decoded model data.

Clause 8: A system comprising at least one processor, the at least one processor being programmed or configured to: transmit a first portion of a machine learning model to at least one computing device remote from the at least one processor, the first portion comprising at least one first layer of the machine learning model configured to process a first input of data collected by the at least one computing device and generate an output; receive, from the at least one computing device, encoded model data comprising the output of the at least one first layer of the machine learning model; decode the encoded model data to produce decoded model data; and generate a classification based on the first input of data by executing a second portion of the machine learning model, the second portion comprising at least one second layer of the machine learning model configured to output the classification based on processing an input of the decoded model data.

Clause 9: The system of clause 8, wherein the at least one processor is further programmed or configured to, in response to receiving the encoded model data from the at least one computing device and decoding the encoded model data: evaluate the decoded model data to determine whether the encoded model data was modified without permission.

Clause 10: The system of clause 8 or clause 9, wherein the at least one processor is further programmed or configured to: (i) in response to determining that the encoded model data was modified without permission: update a total count of instances of unpermitted modifications to model data; and execute, based on the total count of instances, a mitigation process to prevent future unpermitted modifications to model data; and (ii) in response to determining that the encoded model data was not modified without permission: profile historic data of activity of a plurality of computing devices occurring over a first time interval; and generate, further based on the historic data, the classification.

Clause 11: The system of any of clauses 8-10, wherein the first input of data collected by the at least one computing device comprises data of activity of the at least one computing device occurring over a second time interval shorter than the first time interval.

Clause 12: The system of any of clauses 8-11, wherein the at least one processor is further programmed or configured to: receive a transaction request from the at least one computing device; and process the transaction request based on the classification, wherein the machine learning model is a fraud detection model, wherein the first input of data collected by the at least one computing device further comprises user credentials input to the at least one computing device by a user, wherein the historic data of activity comprises historic transaction data of transactions processed by a server in the first time interval, and wherein the classification generated by the at least one processor is based on a likelihood of the transaction request being fraudulent.

Clause 13: The system of any of clauses 8-12, wherein the encoded model data is produced by encryption and compression, and wherein decoding the encoded model data further comprises decrypting and uncompressing the encoded model data to produce the decoded model data.

Clause 14: A computer program product comprising at least one non-transitory computer-readable medium storing one or more instructions that, when executed by at least one processor of a server, cause the at least one processor to: transmit a first portion of a machine learning model to at least one computing device remote from the server, the first portion comprising at least one first layer of the machine learning model configured to process a first input of data collected by the at least one computing device and generate an output; receive, from the at least one computing device, encoded model data comprising the output of the at least one first layer of the machine learning model; decode the encoded model data to produce decoded model data; and generate a classification based on the first input of data by executing a second portion of the machine learning model, the second portion comprising at least one second layer of the machine learning model configured to output the classification based on processing an input of the decoded model data.

Clause 15: The computer program product of clause 14, wherein the one or more instructions further cause the at least one processor to, in response to receiving the encoded model data from the at least one computing device and decoding the encoded model data: evaluate the decoded model data to determine whether the encoded model data was modified without permission.

Clause 16: The computer program product of clause 14 or clause 15, wherein the one or more instructions further cause the at least one processor to, in response to determining that the encoded model data was modified without permission: update a total count of instances of unpermitted modifications to model data; and execute, based on the total count, a mitigation process to prevent future unpermitted modifications to model data.

Clause 17: The computer program product of any of clauses 14-16, wherein the one or more instructions further cause the at least one processor to, in response to determining that the encoded model data was not modified without permission: profile historic data of activity of a plurality of computing devices occurring over a first time interval; and generate, further based on the historic data, the classification.

Clause 18: The computer program product of any of clauses 14-17, wherein the first input of data collected by the at least one computing device comprises data of activity of the at least one computing device occurring over a second time interval shorter than the first time interval.

Clause 19: The computer program product of any of clauses 14-18, wherein the one or more instructions further cause the at least one processor to: receive a transaction request from the at least one computing device; and process the transaction request based on the classification, wherein the machine learning model is a fraud detection model, wherein the first input of data collected by the at least one computing device further comprises user credentials input to the at least one computing device by a user, wherein the historic data of activity comprises historic transaction data of transactions processed by the server in the first time interval, and wherein the classification generated by the at least one processor of the server is based on a likelihood of the transaction request being fraudulent.

Clause 20: The computer program product of any of clauses 14-19, wherein the encoded model data is produced by encryption and compression, and wherein decoding the encoded model data further comprises decrypting and uncompressing the encoded model data to produce the decoded model data.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying figures, in which:

FIG. 1 is a diagram of a non-limiting embodiment or aspect of an environment in which systems, apparatuses, and/or methods, as described herein, may be implemented;

FIG. 2 is a diagram of a non-limiting embodiment or aspect of components of one or more devices of FIG. 1;

FIG. 3 is a flow diagram of a non-limiting embodiment or aspect of a method for secure edge computing of a machine learning model; and

FIG. 4 is a schematic and flow diagram of a non-limiting embodiment or aspect of a system and method for secure edge computing of a machine learning model.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. An “application” or “application program interface” (API) may refer to computer code or other data sorted on a computer-readable medium that may be executed by a processor to facilitate the interaction between software components, such as a client-side front-end and/or server-side back-end for receiving data from the client. An “interface” may refer to a generated display, such as one or more graphical user interfaces (GUIs) with which a user may interact, either directly or indirectly (e.g., through a keyboard, mouse, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, an electronic payment processing network may refer to the communications between one or more entities for processing the transfer of monetary funds to one or more transactions. The electronic payment processing network may include a merchant system, an acquirer system, a transaction service provider, and an issuer system.

Non-limiting embodiments or aspects of the present disclosure are directed to a system, method, and computer program product for secure edge computing of a machine learning model. The present disclosure greatly improves the computational efficiency of a central server by splitting the execution of a machine learning model between at least one remote computing device (e.g., an edge device) and the central server. In this manner, the central server will require a fraction of the computational resources previously required for each instance, in proportion to the number of model layers outsourced to the at least one remote computing device. Moreover, the present disclosure maintains system security by executing a less than entire machine learning model on the at least one remote computing device. In this manner, not all layers and features of the machine learning model, even if decoded, would be accessible to a user of a remote computing device. The described systems and methods herein, therefore, directly reduce the processing demands on a central server, which would allow the central server to engage in additional instances and executions of machine learning models, which improves system throughput.

Furthermore, the present disclosure provides for a check process at the central server to evaluate the encoded model data received from a remote computing device to determine whether the encoded model data was maliciously modified prior to communication to the central server. The central server may track the total count of malicious modifications and engage preventative measures should a threshold count be satisfied. In this manner, repeated offenses may be used as indicators of malicious actors in the system, and non-cooperative remote computing devices can be removed from participation in the system, thereby maintaining overall model accuracy.

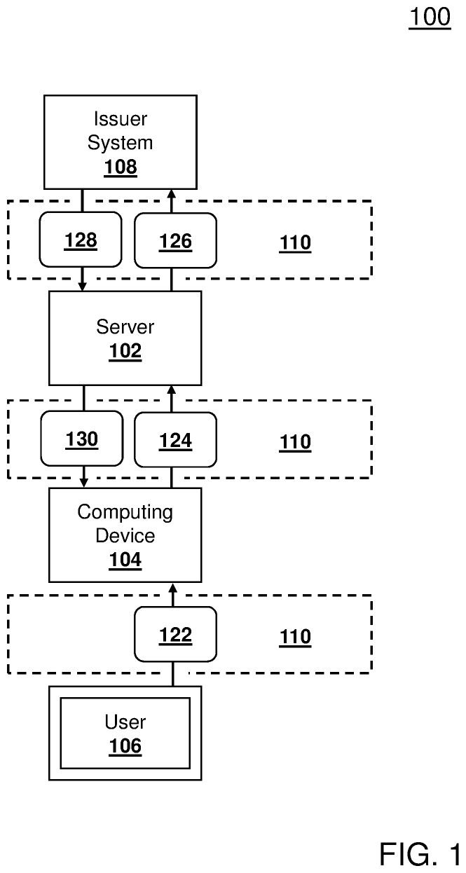

Referring now to FIG. 1, illustrated is a diagram of an example environment 100 in which devices, systems, and/or methods, described herein, may be implemented. As shown in FIG. 1, environment 100 includes at least one server (e.g., including at least one processor) 102, at least one computing device 104, at least one issuer system 108, and at least one communication network 110. The computing device 104 is remote (e.g., communicatively and physically arranged as an independent device) from the server 102. As described herein, machine learning models are executed cooperatively between the server 102 and a computing device 104.

Communication network 110 may include a cellular network (e.g., a long-term evolution (LTE®) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, a mesh network, a beacon network, an intranet, the Internet, a fiber optic-based network, a cloud computing network, and/or the like, and/or a combination of these or other types of networks. Issuer system 108 may include one or more computing devices associated with an issuer that are programmed or configured to communicate with a server 102 over a communication network 110. The communication network 110 used for communication between issuer system 108 and server 102 may be a same or different communication network 110 that was used for communication between server 102 and computing device 104. While the environment 100 is depicted with an issuer system 108, it will be appreciated that the described methods do not require an issuer system 108, and the described methods may be employed for non-financial systems.

Server 102 may include one or more computing devices programmed or configured to communicate with a computing device 104 and an issuer system 108 over a communication network 110. Server 102 may be associated with a transaction service provider, such as part of a transaction processing system. Computing device 104 may include one or more computing devices programmed or configured to communicate with server 102. Computing device 104 and server 102 include separate sets (e.g., collections of one or more) of computing devices. Server 102 may include and/or be associated with a data repository of one or more machine learning models for execution. Server 102 may transmit, via the communication network 110, a first portion of a machine learning model to a computing device 104 remote from the server 102, where the first portion includes one or more initial layers of a machine learning model. The computing device 104 may execute the first portion of the machine learning model based on a first input of data collected by the computing device 104. Execution of the first portion of the machine learning model may generate an output from the last layer of the first portion of the machine learning model. The computing device 104 may include an encoder executed by a processor of the computing device 104 that encrypts and/or compresses the output of the first portion of the machine learning model to produce encoded model data. The computing device 104 may then transmit the encoded model data to the server 102 via the communication network 110.

The server 102 may receive, from the computing device 104, the encoded model data that includes the output of the first portion of the machine learning model. The server 102 may include a decoder executed by a processor of the server 102 that decrypts and/or uncompresses the encoded model data. The server 102 may then execute a second portion of the machine learning model, where the second portion includes one or more second layers of the machine learning model. The decoded output of the first portion of the machine learning model may be used as input to the second portion of the machine learning model. Based on the execution of the second portion of the machine learning model, the server 102 may generate a final output, e.g., a classification, which is ultimately based on the first input of data collected by the computing device 104.

When the server 102 receives the encoded model data from the computing device 102 and decodes the encoded model data, the server 102 may evaluate the decoded model data to determine whether the encoded model data was modified without permission (e.g., maliciously, such as to execute the machine learning model other than intended by the server 102, to falsify the output of the first portion of the machine learning model, and/or the like). The evaluation may be based on a digital signature, a hash, a check of a file's contents, and/or the like. In response to determining that the encoded model data was modified without permission, the server 102 may update a total count of instances of unpermitted modifications to model data. For example, the total count may be specific to the computing device 104 and incremented with each malicious activity. Based on the total count, a mitigation process may be executed by the server 102 to prevent future unpermitted modifications to model data (e.g., preventing some or all future communications with the computing device 104, adding additional security checks to communications with the computing device 104, restricting the types of activity the computing device 104 can engage in with the server 102, and/or the like). The threshold may be as low as one, e.g., a first offense. The mitigation process may also include manual review by personnel associated with the server 102.

In response to determining that the encoded model data was not modified without permission, the server 102 may proceed to execute the second portion of the machine learning model. This post-check process may further include profiling historic data of activity of a plurality of computing devices that occur over a first time interval (e.g., a week, 30 days, 90 days, etc.), and generating, based on the historic data, the classification. In this manner, local input from the computing device 104 may be used alongside a wider pool of historic data from other computing devices 104 in the network to provide a more accurate classification using the machine learning model. It will be further appreciated that the first input of data collected by the at least one computing device may occur over a second time interval that is shorter than the first time interval (e.g., a current communication session, an hour, a day, a week, 30 days, etc.).

In some non-limiting embodiments or aspects, the described system may be implemented in an electronic payment processing network, and the machine learning model to be executed may be a fraud detection model (e.g., a model trained on historic data of fraud and configured to classify individual transactions based on a likelihood of the transaction being fraudulent). For example, the first input of data collected by the computing device 104 (e.g., acting as a payment device) may include user credentials (e.g., a PAN, an account identifier, a username, a password, and/or the like) input to the computing device 104 by a user 106. The first portion of the machine learning model may be executed locally on the computing device 104, which may encode and transmit the output to the server 102. The server 102 may then execute the second portion of the machine learning model using additional historic data of activity that includes historic transaction data of transactions processed by the server in a first time interval. The historic transaction data may include transactions by other users 106 in the network. The classification output by the machine learning model may be a likelihood of the transaction request being fraudulent (e.g., a Boolean output (e.g., yes/no), a categorical output (e.g., no risk, low risk, moderate risk, high risk), a quantitative output (e.g., a percentile score, a risk value score, etc.), and/or the like). If the fraud detection model is executed in connection with an authorization request for a transaction by the computing device 104, the processing of the authorization request may be based on the classification of the transaction. For example, if the transaction is classified as likely to be fraud, then the server 102 may decline to process the authorization request. If the transaction is classified as not likely to be fraud, then the server 102 may proceed to process the authorization request. It will be appreciated that other types of systems may employ the methods described herein.

With further reference to FIG. 1, also shown is an example communication flow for non-limiting embodiments or aspects. For example, described methods may be executed as part of a token service operation. The steps of the communication flow may be executed by one or more computing devices of the components connected by the depicted arrows representing the communication flow.

In step 122, a user 106 may enroll their payment account (e.g., a checking account, a credit card account, etc.) with a digital payment service provider (e.g., an online retailer, mobile wallet, etc.) by entering user credentials into a computing device 104. The user credentials may include a PAN, a security code, and/or other payment account information. The computing device 104 may be associated with the digital payment service provider, and the user 106 may enter their user credentials in a separate user computing device that transmits the user credentials to the computing device 104 of the digital payment service provider via a communication network 110. In some non-limiting embodiments or aspects, the user 106 may enter their user credentials directly to the computing device 104 of the digital payment service provider.

In step 124, the computing device 104 of the digital payment service provider may transmit a request for a payment token from a server 102 associated with a transaction service provider. The request may be transmitted via a communication network 110, which may be a separate communication network 110 from the one used for step 122. In step 126, after receiving the request, the server 102 of the transaction service provider may forward the request (e.g., via a same or different communication) to an issuer system 108 associated with the payment account of the user 106 (e.g., the user's 106 financial institution). The issuer system 108 may then review the request and transmit a response, in step 128, to the server 102 of the transaction service provider indicating whether the server 102 has permission to implement a token associated with the payment account of the user 106.

If the issuer system 108 approves the use of a token for the payment account, the server 102 may associate and/or replace the user's 106 PAN with a unique digital identifier (e.g., a token) for use in transactions. In step 130, the server 102 may transmit the token to the token requester (e.g., the digital payment service provider) for online and mobile (e.g., NFC) payment use. A payment token can be limited to a specific device of the user 106 (e.g., a mobile device), to a specific e-commerce merchant, to a specific number of transactions (e.g., five, ten, etc., before expiring), and/or the like. The above described token process and communications between the computing device 104 and server 102 may be executed in parallel with the edge computing methods described herein, e.g., to authenticate the request by the user 106, to execute a fraud detection model, to generate the token, and/or the like.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

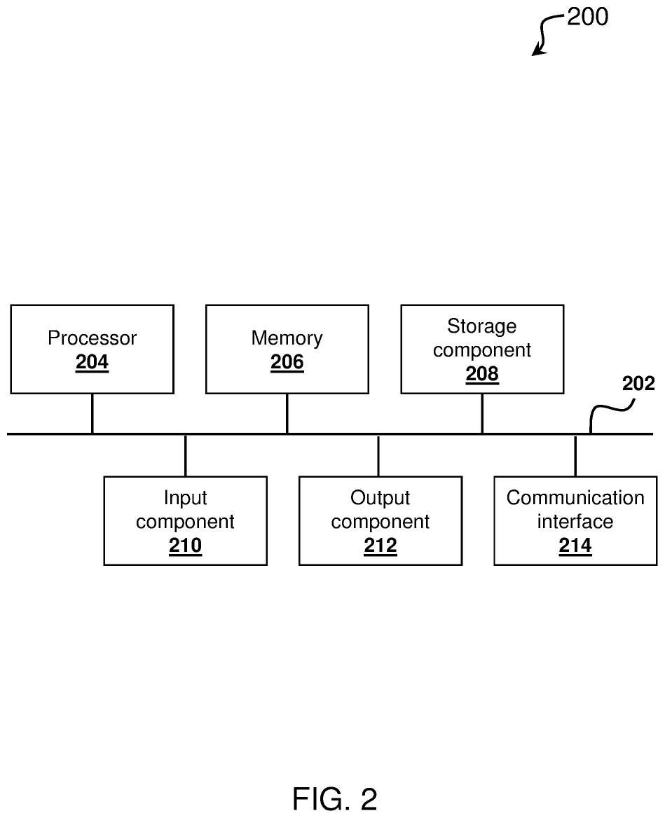

Referring now to FIG. 2, illustrated is a diagram of example components of device 200. Device 200 may correspond to one or more devices of a server 102, a computing device 104, an issuer system 108, and/or a communication network 110. In some non-limiting embodiments or aspects, one or more devices of the foregoing may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi© interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database, and/or the like). Device 200 may be capable of receiving information from, storing information in, communicating information to, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

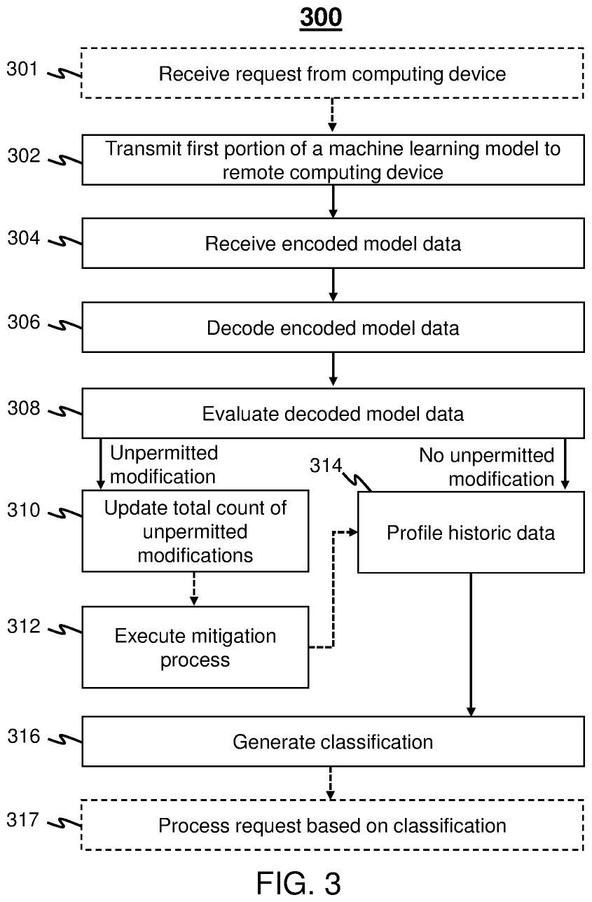

Referring now to FIG. 3, provided is a method 300 for secure edge computing of a machine learning model, according to non-limiting embodiments or aspects. The steps of method 300 may be executed by a server 102 or other computing device 104. One or more steps of method 300 may be executed by a same or different computing device 104 as another step of method 300.

In some non-limiting embodiments or aspects, the machine learning model to be implemented may be a fraud detection model. In the case example, in step 301, a request may be received from a computing device 104. For example, server 102 may receive a transaction request from at least one computing device 104. The following steps may be executed in response to the transaction request. It will also be appreciated that the following steps may be executed as a general framework for other types of machine learning models.

In step 302, a first portion of a machine learning model may be transmitted to a remote computing device 104. For example, server 102 may transmit a first portion of a machine learning model to at least one computing device 104 remote from the server 102. The first portion may include at least one first layer (e.g., one or more first layers) of a machine learning model. The layers may be fully connected neural network layers, convolutional neural network layers, and/or the like. The layers of the first portion may include one or more input layers, hidden layers, and output layers. The first portion may be configured to process a first input of data collected by the at least one computing device 104 and generate an output.

In step 304, encoded model data may be received. For example, server 102 may receive, from the at least one computing device 104, encoded model data including the output of the at least one first layer of the machine learning model. The encoded model data may include the encrypted and/or compressed output of the first portion of the machine learning model.

In step 306, the encoded model data may be decoded. For example, server 102 may decode (e.g., decrypt and/or uncompress) the encoded model data to produce decoded model data. The decoded model data may include the output of the first portion of the machine learning model, which may be used as an input to the second portion of the machine learning model.

In step 308, the decoded model data may be evaluated. For example, server 102 may evaluate the decoded model data to determine whether the encoded model data was modified without permission. In some non-limiting embodiments or aspects, examples of modifications made without permission may include, but are not limited to, falsifying an output of the first portion of the machine learning model, corrupting the output of the first portion of the machine learning model, injecting malicious code to encoded model data, and/or the like.

In step 310, in response to determining that the encoded model data was modified without permission, the total count of unpermitted modifications may be updated. For example, server 102 may, in response to determining in step 308 that the encoded model data was modified without permission, update (e.g., increment) a total count of instances of unpermitted modifications to model data. Further, in response to determining that the encoded model data was modified without permission, one or more mitigation processes may be executed in step 312. For example, server 102 may, based on the total count of instances of unpermitted modifications to model data (e.g., a threshold being satisfied), execute a mitigation process to prevent future unpermitted modifications to model data.

In response to determining that the encoded model data was not modified without permission, the method 300 may proceed to step 316. Alternatively or additionally, the method 300 may proceed to step 314. In step 314, historic data may be profiled. For example, server 102 may profile (e.g., store, use as model input, and/or analyze) historic data of activity (e.g., network activity, such as transaction data) of a plurality of computing devices occurring over a first time interval. The activity may have occurred in a first time interval preceding and/or immediately preceding and including method 300, in which the historic data is used as a part of step 314.

In step 316, a classification may be generated. For example, server 102 may generate a classification based on the first input of data collected by the computing device 104. The classification may be generated by executing a second portion of the machine learning model that uses as input, at least partially, the output of the first portion. The second portion may include one or more second layers of the machine learning model that are configured to output the classification based on processing an input of the decoded model data.

In some non-limiting embodiments or aspects, where the machine learning model is a fraud detection model, the original request from the computing device 104 in step 301 may be processed in step 317. For example, server 102 may process the transaction request of the computing device 104 based on the classification generated in step 316. The classification may be a likelihood of the transaction request being fraudulent. When the classification indicates the transaction request is not likely to be fraud, server 102 may proceed to communicate with one or more issuer systems and/or acquirer systems to settle the transaction. When the classification indicates the transaction request is likely to be fraud, server 102 may decline to proceed with further processing of the transaction. As noted in connection with step 301, it will be appreciated that other types of models may be employed in non-payment system contexts for method 300.

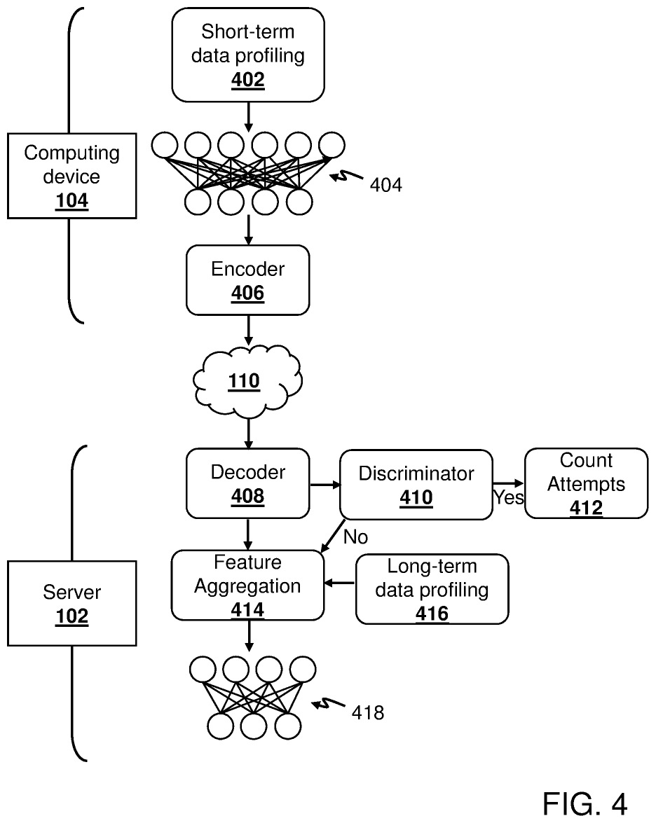

Referring now to FIG. 4, provided is a schematic and flow diagram depicting non-limiting embodiments or aspects of a system and method for secure edge computing of a machine learning model. The system may include at least one server (e.g., including at least one processor) 102, at least one computing device 104 remote from the at least one server 102, and a communication network 110. As depicted, at least steps 402, 404, and 406 may be executed by the at least one computing device 104. At least steps 408, 410, 412, 414, 416, and 418 may be executed by the at least one server 102. Computing device 104 and server 102 may communicate via one or more communication networks 110.

In step 402, the at least one computing device 104 may profile short-term data that is generated on the at least one computing device 104 by feature engineering. The profiling results may be the input of the first portion of the machine learning model. In step 404, the at least one computing device 104 may receive a first portion of a machine learning model from the at least one server 102 and execute one or more first layers of the machine learning model to generate an output of the first portion of the machine learning model.

In step 406, the at least one computing device 104 may use an encoder process to encode the output of the first portion of the machine learning model. Encoding may include encryption and/or compression of the output data. The encrypted model data, which includes the output, may be transmitted from the at least one computing device 104 to the server 102 via the communication network 110.

In step 408, the at least one server 102 may use a decoder process to decode the encrypted model data received from the at least one computing device 104. Decoding may include decryption and/or uncompression of the encrypted model data. In step 410, the at least one server 102 may use a discriminator process to evaluate the decoded model data to determine whether the encoded model data was modified without permission. If the encoded model data was modified without permission, the at least one server 102 may update a total count of instances of unpermitted modifications to the model data in step 412. If the encoded model data was not modified without permission, the at least one server 102 may proceed to feature aggregation in step 414.

In step 416, the at least one server 102 may profile the long-term data collected by the at least one server 102 (e.g., historic data) and aggregate the profiling results with the decoded model data in step 414. In step 418, the at least one server 102 may proceed to execute the remaining layers of the machine learning model (e.g., the second portion) to finish the classification (e.g., inference) based on the short-term and long-term data inputs.

Although the disclosure has been described in detail for the purpose of illustration based on what is currently considered to be the most practical and non-limiting embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
transmitting, with a server comprising at least one processor, a first portion of a machine learning model to at least one computing device remote from the server, the first portion comprising at least one first layer of the machine learning model configured to process a first input of data collected by the at least one computing device and generate an output;
receiving, with the server from the at least one computing device, encoded model data comprising the output of the at least one first layer of the machine learning model;
decoding, with the server, the encoded model data to produce decoded model data; and
generating, with the server, a classification based on the first input of data by executing a second portion of the machine learning model, the second portion comprising at least one second layer of the machine learning model configured to output the classification based on processing an input of the decoded model data.

2. The computer-implemented method of claim 1, further comprising, in response to receiving the encoded model data from the at least one computing device and decoding the encoded model data:
evaluating, with the server, the decoded model data to determine whether the encoded model data was modified without permission.

3. The computer-implemented method of claim 2, further comprising, in response to determining that the encoded model data was modified without permission:
updating, with the server, a total count of instances of unpermitted modifications to model data; and
executing, with the server and based on the total count of instances, a mitigation process to prevent future unpermitted modifications to model data.

4. The computer-implemented method of claim 2, further comprising, in response to determining that the encoded model data was not modified without permission:
profiling, with the server, historic data of activity of a plurality of computing devices occurring over a first time interval; and
generating, with the server and further based on the historic data, the classification.

5. The computer-implemented method of claim 4, wherein the first input of data collected by the at least one computing device comprises data of activity of the at least one computing device occurring over a second time interval shorter than the first time interval.

6. The computer-implemented method of claim 4, further comprising:
receiving, with the server, a transaction request from the at least one computing device; and
processing, with the server, the transaction request based on the classification,
wherein the machine learning model is a fraud detection model, wherein the first input of data collected by the at least one computing device further comprises user credentials input to the at least one computing device by a user, wherein the historic data of activity comprises historic transaction data of transactions processed by the server in the first time interval, and wherein the classification generated by the server is based on a likelihood of the transaction request being fraudulent.

7. The computer-implemented method of claim 1, wherein the encoded model data is produced by encryption and compression, and wherein decoding the encoded model data further comprises decrypting and uncompressing the encoded model data to produce the decoded model data.

8. A system comprising at least one processor, the at least one processor being programmed or configured to:
transmit a first portion of a machine learning model to at least one computing device remote from the at least one processor, the first portion comprising at least one first layer of the machine learning model configured to process a first input of data collected by the at least one computing device and generate an output;
receive, from the at least one computing device, encoded model data comprising the output of the at least one first layer of the machine learning model;
decode the encoded model data to produce decoded model data; and
generate a classification based on the first input of data by executing a second portion of the machine learning model, the second portion comprising at least one second layer of the machine learning model configured to output the classification based on processing an input of the decoded model data.

9. The system of claim 8, wherein the at least one processor is further programmed or configured to, in response to receiving the encoded model data from the at least one computing device and decoding the encoded model data:
evaluate the decoded model data to determine whether the encoded model data was modified without permission.

10. The system of claim 9, wherein the at least one processor is further programmed or configured to:
(i) in response to determining that the encoded model data was modified without permission:
update a total count of instances of unpermitted modifications to model data; and
execute, based on the total count of instances, a mitigation process to prevent future unpermitted modifications to model data; and
(ii) in response to determining that the encoded model data was not modified without permission:
profile historic data of activity of a plurality of computing devices occurring over a first time interval; and
generate, further based on the historic data, the classification.

11. The system of claim 10, wherein the first input of data collected by the at least one computing device comprises data of activity of the at least one computing device occurring over a second time interval shorter than the first time interval.

12. The system of claim 10, wherein the at least one processor is further programmed or configured to:
receive a transaction request from the at least one computing device; and
process the transaction request based on the classification,
wherein the machine learning model is a fraud detection model, wherein the first input of data collected by the at least one computing device further comprises user credentials input to the at least one computing device by a user, wherein the historic data of activity comprises historic transaction data of transactions processed by a server in the first time interval, and wherein the classification generated by the at least one processor is based on a likelihood of the transaction request being fraudulent.

13. The system of claim 8, wherein the encoded model data is produced by encryption and compression, and wherein decoding the encoded model data further comprises decrypting and uncompressing the encoded model data to produce the decoded model data.

14. A computer program product comprising at least one non-transitory computer-readable medium storing one or more instructions that, when executed by at least one processor of a server, cause the at least one processor to:
transmit a first portion of a machine learning model to at least one computing device remote from the server, the first portion comprising at least one first layer of the machine learning model configured to process a first input of data collected by the at least one computing device and generate an output;
receive, from the at least one computing device, encoded model data comprising the output of the at least one first layer of the machine learning model;
decode the encoded model data to produce decoded model data; and
generate a classification based on the first input of data by executing a second portion of the machine learning model, the second portion comprising at least one second layer of the machine learning model configured to output the classification based on processing an input of the decoded model data.

15. The computer program product of claim 14, wherein the one or more instructions further cause the at least one processor to, in response to receiving the encoded model data from the at least one computing device and decoding the encoded model data:
evaluate the decoded model data to determine whether the encoded model data was modified without permission.

16. The computer program product of claim 15, wherein the one or more instructions further cause the at least one processor to, in response to determining that the encoded model data was modified without permission:
update a total count of instances of unpermitted modifications to model data; and
execute, based on the total count of instances, a mitigation process to prevent future unpermitted modifications to model data.

17. The computer program product of claim 15, wherein the one or more instructions further cause the at least one processor to, in response to determining that the encoded model data was not modified without permission:
profile historic data of activity of a plurality of computing devices occurring over a first time interval; and
generate, further based on the historic data, the classification.

18. The computer program product of claim 17, wherein the first input of data collected by the at least one computing device comprises data of activity of the at least one computing device occurring over a second time interval shorter than the first time interval.

19. The computer program product of claim 17, wherein the one or more instructions further cause the at least one processor to:
receive a transaction request from the at least one computing device; and
process the transaction request based on the classification,
wherein the machine learning model is a fraud detection model, wherein the first input of data collected by the at least one computing device further comprises user credentials input to the at least one computing device by a user, wherein the historic data of activity comprises historic transaction data of transactions processed by the server in the first time interval, and wherein the classification generated by the at least one processor of the server is based on a likelihood of the transaction request being fraudulent.

20. The computer program product of claim 14, wherein the encoded model data is produced by encryption and compression, and wherein decoding the encoded model data further comprises decrypting and uncompressing the encoded model data to produce the decoded model data.
